(19) United States
(12) Patent Application Publication
(10) Pub. No.: US 2023/0366243 A1
(43) Pub. Date: Nov. 16, 2023

(54) Adjustable Lock Mechanism

(71) Applicant: Kuat Innovations LLC, Springfield, MO (US)

(72) Inventor: Luke Kuschmeader, Springfield, MO (US)

(73) Assignee: Kuat Innovations LLC, Springfield, MO (US)

(21) Appl. No.: 18/312,281

(22) Filed: May 4, 2023

Related U.S. Application Data
(60) Provisional application No. 63/340,423, filed on May 10, 2022.

(51) Int. Cl. E05B 71/00

(52) U.S. Cl. CPC E05B 71/00

(57) ABSTRACT

An integrated lock for a bicycle rack allows the position of the lock cable to be adjusted along the length of the bicycle rack tray to best accommodate locking of the bicycle to the rack. This allows a bicycle to be placed facing either direction on the bicycle rack. The lock cable can be positioned on the bicycle rack at a preferred location for locking the bicycle, such as near the rear wheel of the bicycle. The lock cable may also be stored inside a channel in the support tray when not in use. The channel may provide both the storage cavity and the adjustment mechanism for the lock cable.

### CROSS-REFERENCE TO RELATED APPLICATIONS

This application claims the benefit of U.S. Pat. Application Serial No. 63/340,423 filed on May 10, 2022, the disclosure of which is incorporated herein by reference.

### BACKGROUND

### Field of the Invention

This disclosure is in the field of equipment racks with integrated locks. More specifically, this disclosure is in the field of locks that are integrated into a bicycle stand or rack. More specifically, this disclosure is in the field of integrated bicycle locks with adjustable positioning on the bicycle rack.

### SUMMARY OF THE INVENTION

In various embodiments, the adjustable lock mechanism comprises a cable member having a flexible cable, a retention member attached to the cable at a first point thereon, and a lock bolt attached to the cable at a second point thereon. In some embodiments the retention member is translatably disposed in a cavity disposed in or on the bicycle rack. The cable may be stored in the cavity when not in use. When it is to be used the cable is pulled out of the cavity except the retention member remains in the cavity. The retention member is translated within the cavity to a point at which the user desires to locate it, and then the cable is disposed through or around a portion of the bicycle frame to be secured to the rack. The lock bolt is then secured to a lock core attached to the rack or to the cable.

### BRIEF DESCRIPTION OF THE DRAWINGS

FIG. 1 is a perspective view of a bicycle rack incorporating an embodiment of the adjustable lock mechanism.

FIG. 2 is a detail perspective view of a portion of a bicycle rack incorporating an embodiment of the adjustable lock mechanism.

FIG. 3 is a cross-sectional view of a bicycle rack incorporating an embodiment of the adjustable lock mechanism.

FIG. 4 is a cross-sectional view of a portion of a bicycle rack incorporating an embodiment of the adjustable lock mechanism.

FIG. 5 is a cross-sectional view of a portion of a bicycle rack incorporating an embodiment of the adjustable lock mechanism.

FIG. 6 is a perspective view of a portion of a bicycle rack incorporating an embodiment of the adjustable lock mechanism.

FIG. 7 is a cross-sectional view of a portion of a bicycle rack incorporating an embodiment of the adjustable lock mechanism.

FIG. 8 is a perspective view of a portion of a bicycle rack incorporating an embodiment of the adjustable lock mechanism.

FIG. 9 is a top view of a portion of a bicycle rack incorporating an embodiment of the adjustable lock mechanism.

FIG. 10 is a perspective view of a portion of a bicycle rack incorporating an embodiment of the adjustable lock mechanism.

FIG. 11 is a perspective view of a portion of a bicycle rack incorporating an embodiment of the adjustable lock mechanism.

FIG. 12A is a perspective view of a portion of a bicycle rack with two wheel-securement arms.

FIG. 12B is a perspective view of a portion of a bicycle rack with two wheel-securement arms.

FIG. 12C is a detail perspective view of an embodiment of a wheel arm retention device in a latched configuration.

FIG. 12D is a detail perspective view of an embodiment of a wheel arm retention device in an unlatched configuration.

FIG. 13A is a partial view of an alternative cable for an additional embodiment of the adjustable lock mechanism.

FIG. 13B is a partial view of an alternative cable for an additional embodiment of the adjustable lock mechanism.

### DETAILED DESCRIPTION

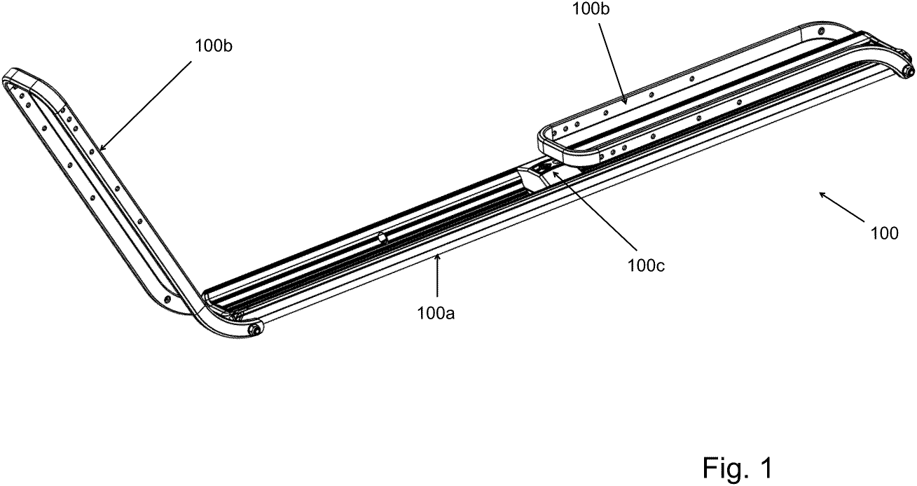

Many bicycle racks incorporate integrated lock cables that are permanently attached to the bicycle rack and may be used to lock a bicycle onto the rack. Depending on the position of the location of the cable on the rack and the position of the bicycle on the rack, these locks may not be optimally positioned to reach desired sections of the bicycle frame for locking, such as the rear triangle of the bicycle frame. This is especially true for bicycle racks such as the rack depicted in FIG. 1 that allow a bicycle to be installed facing either direction or translated to varying positions along the length of the bicycle rack.

The bicycle rack 100 depicted in FIG. 1 comprises a platform or support member 100a on which a bicycle may be disposed facing either direction. Each of the wheels of the bicycle may be disposed in one of the wheel securement devices 100b, which may comprise wheel arms, retracting hook arms, frame clamps or other mechanisms for holding the bicycle on the platform 100a. In the depicted rack, the bicycle may be disposed at any position along the platform 100a from one end to the other. As a result, this style of bicycle rack affords many more positions for bicycle loading than in some other styles of bicycle rack. Thus, it is desirable to provide a lock mechanism that is integrated with the bicycle rack but that can be positioned on the bicycle rack by the user to an optimal position based on the position of a bicycle on the rack. Embodiments of the claimed invention are not limited to bicycle racks of the style shown in FIG. 1.

In varying embodiments, the inventive, integrated, adjustable lock mechanism 102 comprises a retention member 102e and a cable member 102a attached to the retention member 102e. The retention member 102e is movably secured to the bicycle rack 100 to allow adjustment of the position of the integrated lock mechanism 102 on the rack. The cable member 102a is affixed to the retention member 102e and may be disposed through the frame members of a bicycle to prevent its removal from the bicycle rack 100. In some embodiments, once the cable member 102a is passed through at least one opening in the frame of a bicycle it is then secured by a lock component 100c.

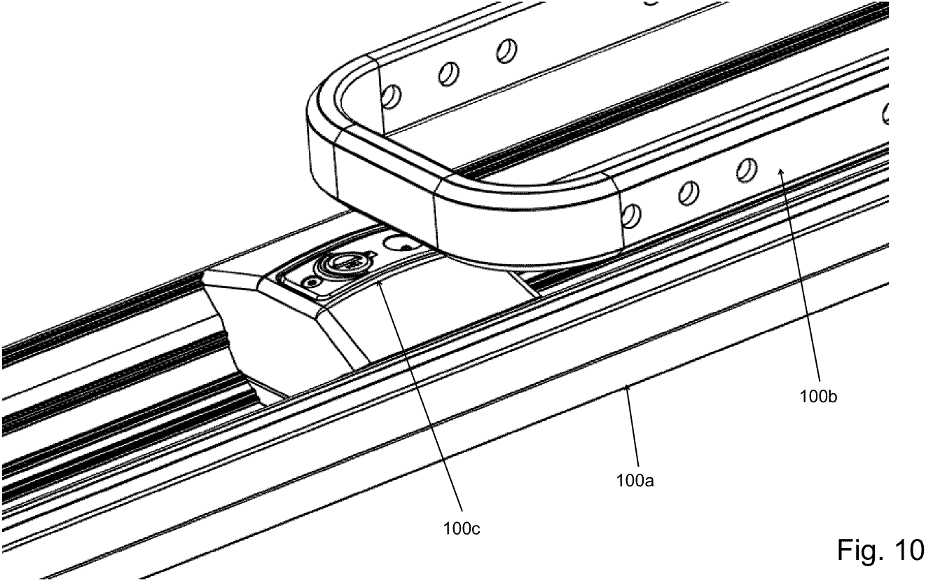

In some embodiments the cable member 102a may have a lock component 100c attached to it for receiving another portion of the cable member 102a such as shown in U.S. Pat. No. 10,668,866. For example, an end of the cable member 102a may comprise a bolt 102c for insertion into the lock component 100c and the lock component 100c may be slidably disposed on the cable. In other embodiments the lock component 100c may be attached to or integrated into the rack 100 such as the depicted attachment of lock component 100c to platform 100a in FIGS. 1, 6, and 10. In various embodiments the lock component 100c comprises a lock for receiving and securing the bolt 102c, and a key mechanism for locking or unlocking the lock core or for releasing the bolt from the lock core.

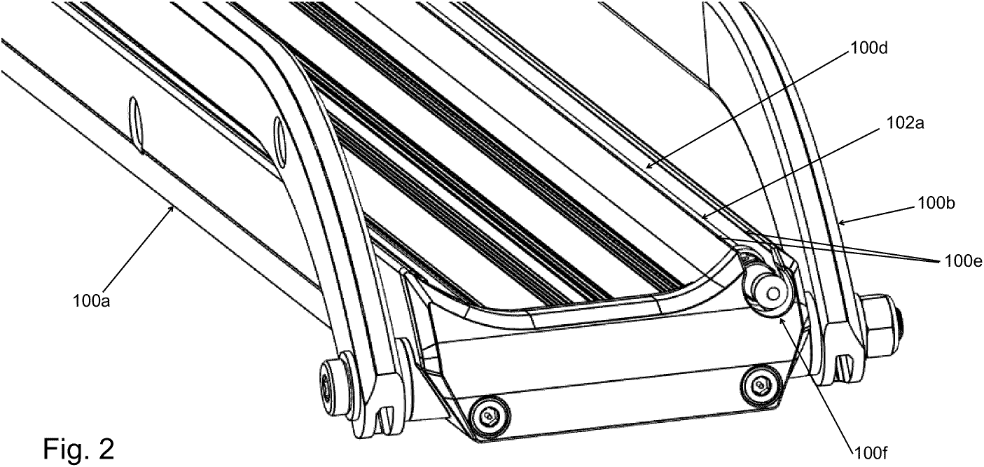

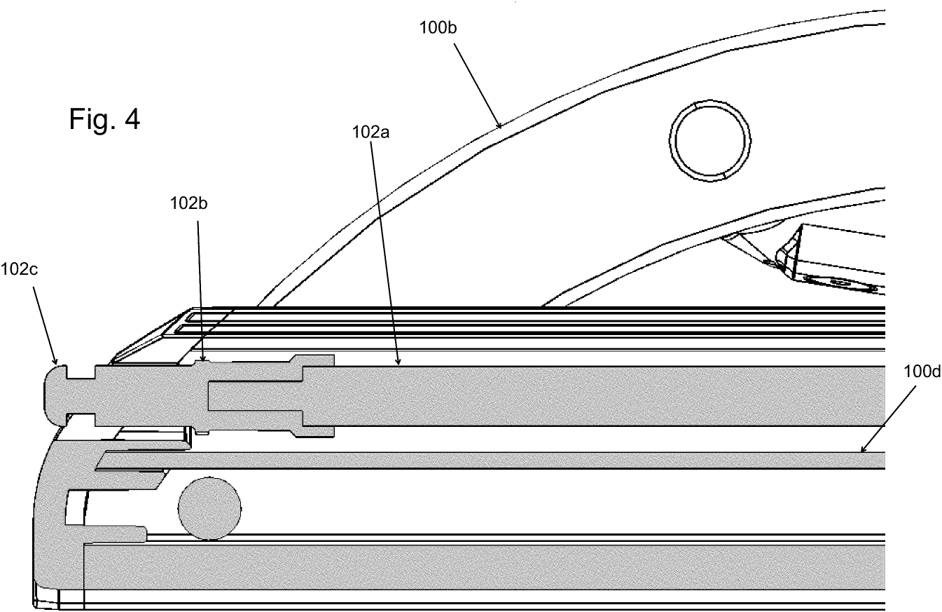

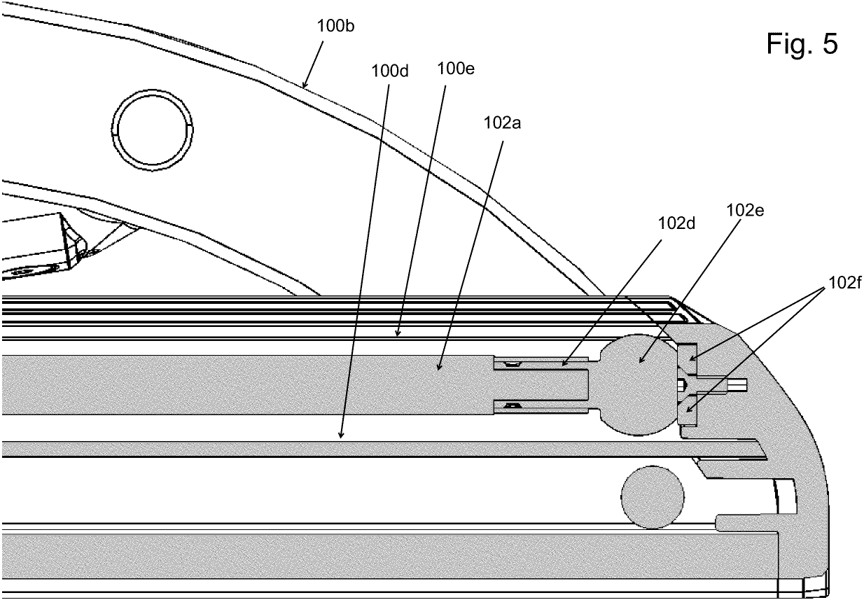

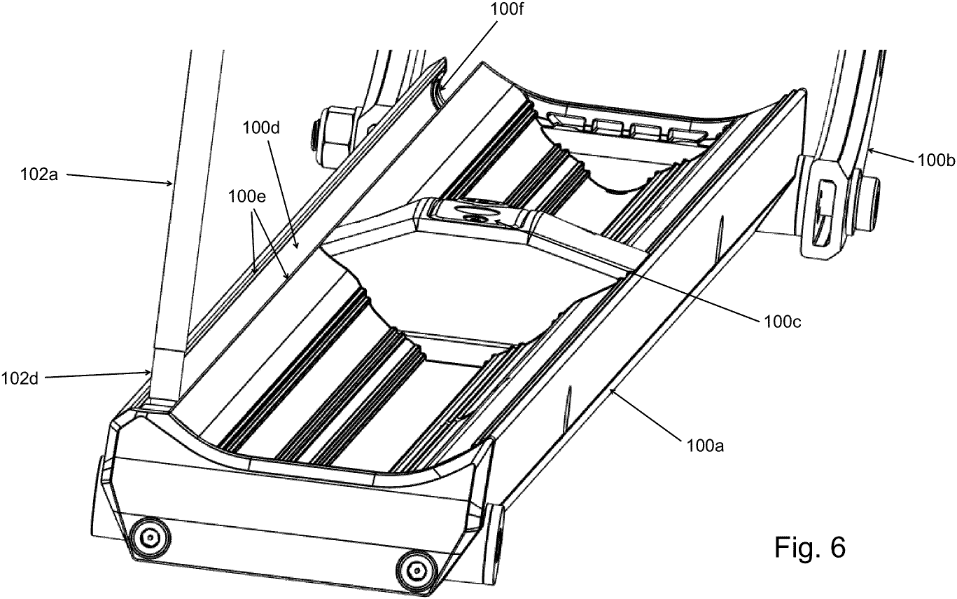

In some embodiments such as the one depicted in FIGS. 1 through 11, the cable member 102a and retention member 102e are disposed in a cavity 100d in the bicycle rack 100 when not in use. FIG. 2 depicts a detailed view of one end of an embodiment of the bicycle rack 100 with the cable member 102a stowed inside cavity 100d in the platform 100a. In the depicted embodiment the cavity 100d extends along one side of the platform 100a. A slit, slot, or aperture between edges 100e extends along some portion of the cavity 100d to allow the cable member 102 to be positioned at a desired position along the slot 100e. As shown in FIGS. 6 through 9, in varying embodiments at least some portion of cable member 102a fits through slot 100e and can slide to any point along slot 100e.

In varying embodiments, the slot 100e may extend along the entire length of the cable cavity 102d or only a portion thereof. The cable cavity 100d is designed to allow the retention member 102e to translate along a longitudinal (or lengthwise) direction 106 of the platform 100a, or at least along some portion thereof. The slot 100e is designed to prevent the retention member from exiting from the cable cavity 100d. Thus, the retention member 102e is captured or trapped in the cable cavity 100d but is able to translate along at least some portion of the length of the cable cavity 100d so that the cable member 102a may be moved to a desired position along the length of the cavity 100d.

One end of the cable cavity 100d, such as the end shown in FIG. 2, may have an aperture 100f in an end of the support member 100a that is larger in size than slot 100e but still prevents retention member 102e from exiting the end of the cable cavity 100d. The size of the aperture may be set by flanges as shown in the figures. This aperture 100f is provided in some embodiments to allow optional collars 102g to be placed on the cable 102a at one or more points along its length. These collars may be sized to prevent the midsections of the cable 102a from moving through slot 100e when the cable lock is not in use, but to allow cable 102a to be pulled out of the aperture 102f at the end of the cable cavity 100d. This embodiment requires a user to pull the cable 102a out through the aperture until a sufficient amount of cable 102a is outside the cavity 100d. Then the cable 102a can be slid along the slot 100e to a desired position for securing a bicycle or other piece of equipment. In some cases, the entire cable 102a is extracted out from the cable cavity 100d and only the retention member 102e remains in the cable cavity 100d.

When a user desires to lock a bicycle onto the rack, the cable 102a may be extracted outwardly from the cavity 100d through an opening or aperture 100f in the platform 100a. The retention member is able to translate within the cavity 100d but cannot be removed from the cavity 100d. In the depicted embodiment a slot 100e is provided in the platform that allows the cable to extend through the slot and extend outwardly from the platform 100a at any point along its length.

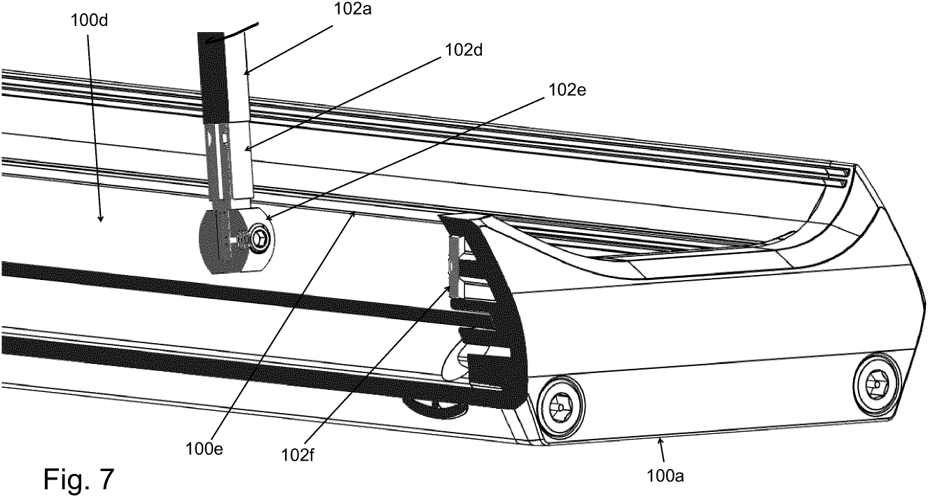

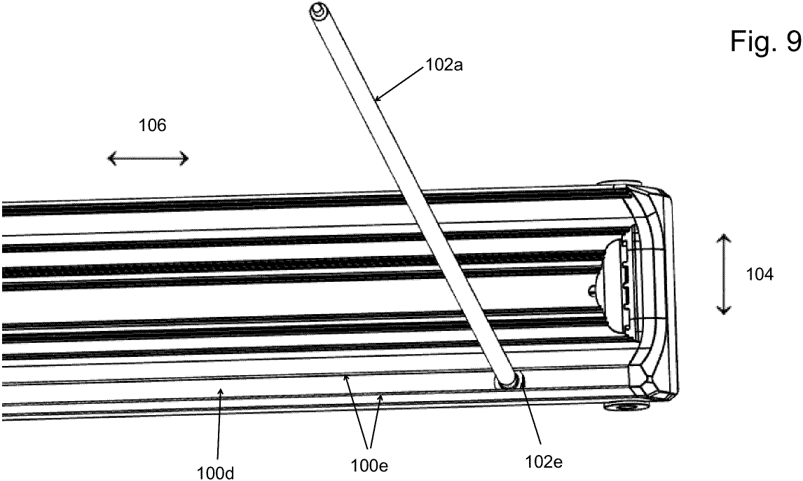

As shown in FIG. 9 and others, in the depicted embodiment the cavity 102d and slot 102e extend parallel to the longitudinal direction 106 of the bicycle support platform 100a. In this embodiment they are disposed adjacent to one side of the platform 102a but could be disposed at other locations thereon such as in the middle of the platform 102a. FIG. 7 depicts a cross-sectional view of a portion of this embodiment in a plane that is parallel to the longitudinal direction 106.

As shown in FIG. 11, in some embodiments one or more collars 102g may be provided on the cable 102a to prevent it from passing through the aperture/slot 102e at points along its length. In the depicted embodiment the diameter of the collars 102g is larger than the width of the slot 100e. This prevents undesired movement of midsections of the cable through the slot 100e when the cable is in the stowed position. When the user has extracted a sufficient length of the cable 102a through aperture 100f the cable 102a may be pulled into slot 100e. Then the cable 102a may be translated along the longitudinal axis 106 of the rack 100 by sliding the retention member 102e inside the cavity 100d. The cable 102a extends outwardly through the slot 100e toward the bicycle on the platform 100a. In some embodiments the cable is secured by a lock 100c on the platform 100a, by a lock that slides long the cable 102a, by joining it to the end of another security cable, or by another similar configuration for a lock used with a security cable.

In the depicted embodiment, the cable cavity 100d is substantially cylindrical in shape along all or a portion of its length with a circular cross-section when viewed transversely. In other embodiments the cable cavity 100d might be square or rectangular in cross-section in both longitudinal and transverse directions. In some embodiments the cable cavity may be an elliptic cylinder, cuboid, capsule (spherocylinder), t-channel, or other similar shape. In some versions the cross-sectional shape may vary along the length of the cavity 100d.

In the depicted embodiment, the retention member 102e comprises a spherical element attached to the end 102d of the cable 102a. The use of a spherical retention member 102e allows the retention member 102e to rotate within a cylindrical cavity 102d so that when the cable is deployed to secure a bicycle the retention member 102e is rotated so that cable 102a exits straight through (or at any angle to) the slot 100e such as the configuration shown in FIGS. 6, 7, 8, and 9. In the depicted embodiment the diameter of the retention member 102e is slightly smaller than the diameter of the cylindrical cavity 100d.

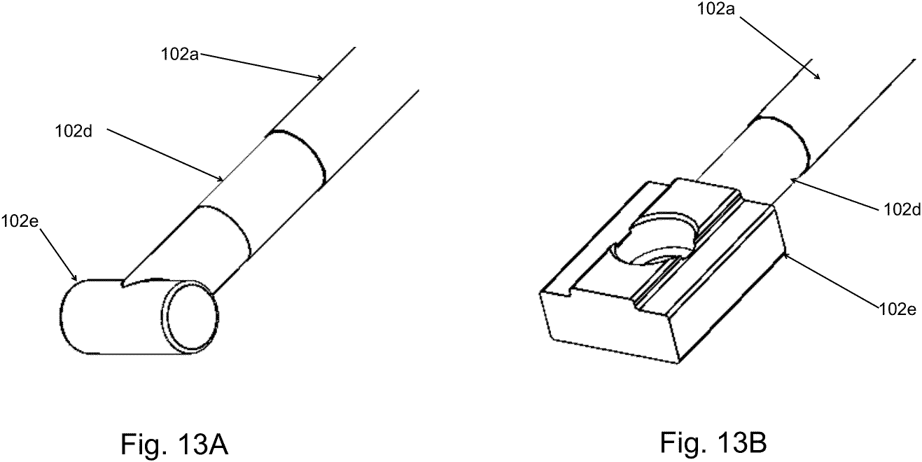

In other embodiments such as the cable depicted in FIG. 13A the retention member 102e may comprise a cylindrical element disposed with its longitudinal axis parallel to the transverse direction 104 with respect to the cavity 100d. If the cavity 100d is a cuboid volume such as a t-channel, then the cylindrical retention member 102e would rotate to allow the cable 102a to be directed either along the longitudinal axis of the cavity 100d or upward through slot 100e at any desired angle.

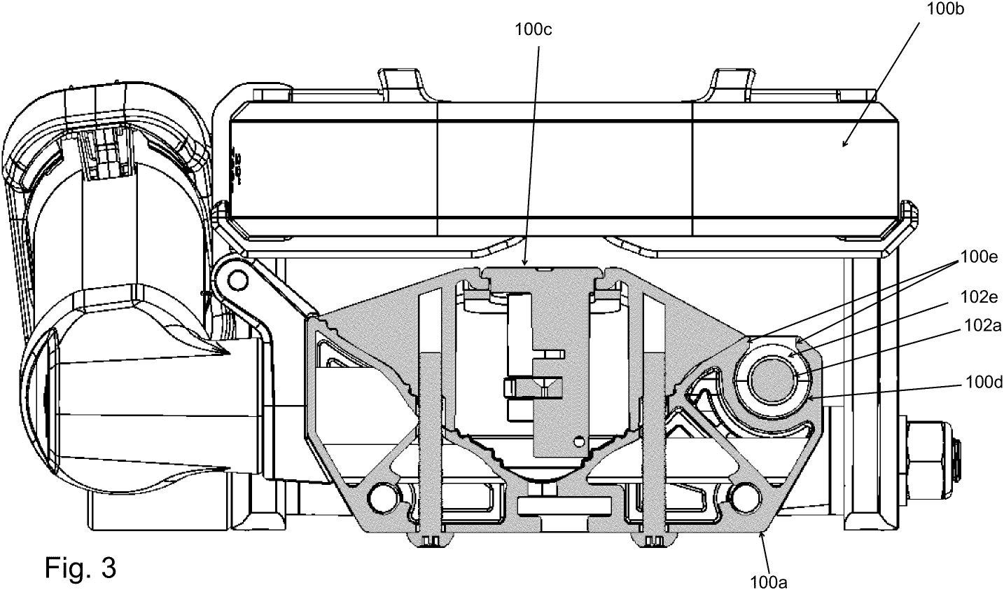

In other embodiments such as the cable depicted in FIG. 13B, the retention member 102e may not rotate within the cavity 100d but only translates within the cavity 100d along its longitudinal axis in direction 106. FIG. 3 depicts a cross-sectional view of an embodiment in a plane parallel to transverse direction 104. The embodiment shown in FIG. 3 is shaped to slide along the length of a t-channel.

In the depicted embodiment the cable tip 102b includes features that may engage with the lock core to secure the end of the cable 102a around a bicycle frame element. This may include a lock bolt 102c extending from the end of the tip 102b. In a preferred embodiment a portion of the cable tip 102a is sufficiently large in diameter to prevent its passage through the slot 100e while still fitting through aperture 100f. In the depicted embodiment a set screw secures the retention member 102e on the cable end 102d.

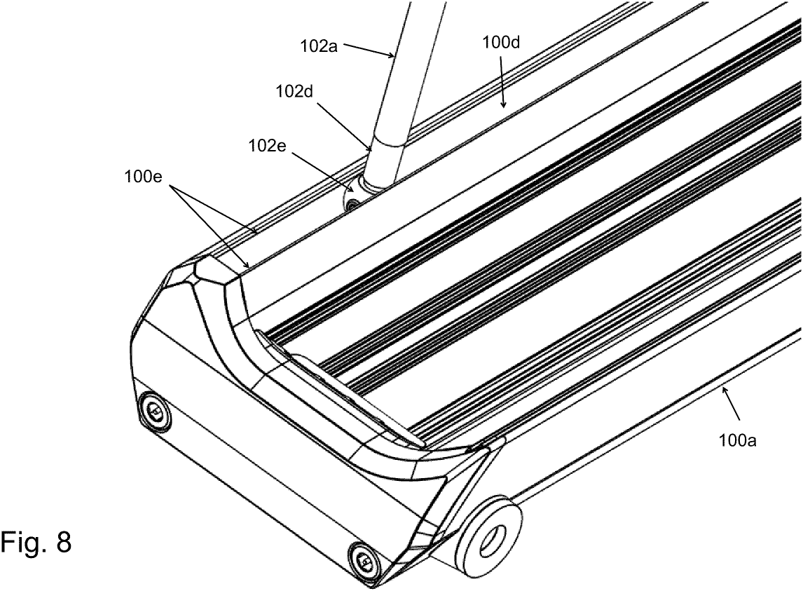

In varying embodiments the point at which the cable 102a extends outwardly through the slot 100e may be referred to as the cable attachment point. As can be seen by comparing FIGS. 6 and 8, the cable attachment point translates along the slot 100e as the retention member 102e moves in the cavity 100d. The cable 102a may be made of a material commonly used for security cables or bicycle lock cables that is flexible and resistant to cutting or sawing operations.

In varying embodiments one or more of the cable tip 102b, lock bolt 102c, cable end 102d, and retention member 102e may be formed from a magnetic material. In these embodiments a magnetic retention element 102f may be provided to attract one of the foregoing elements when it is in the stowed position to hold the cable 102 in place. The depicted embodiment includes a magnet 102f attached to one end of the cavity 100d. When the cable 102 is stowed in the cavity 100d then magnet 102f contacts, or is close enough to, the retention member 102e to hold it in place until a user applies a force to separate them.

The depicted embodiment is shown as incorporated into a bicycle rack. However other embodiments of the adjustable lock mechanism may be used with other types of equipment racks. For example, embodiments of the adjustable lock mechanism may be incorporated into a roof rack for a vehicle, a rack for use on the rear door of a van, cargo racks for use on a truck bed, a roof tent with storage attachments on the upper surface of the roof tent, and other similar types of devices.

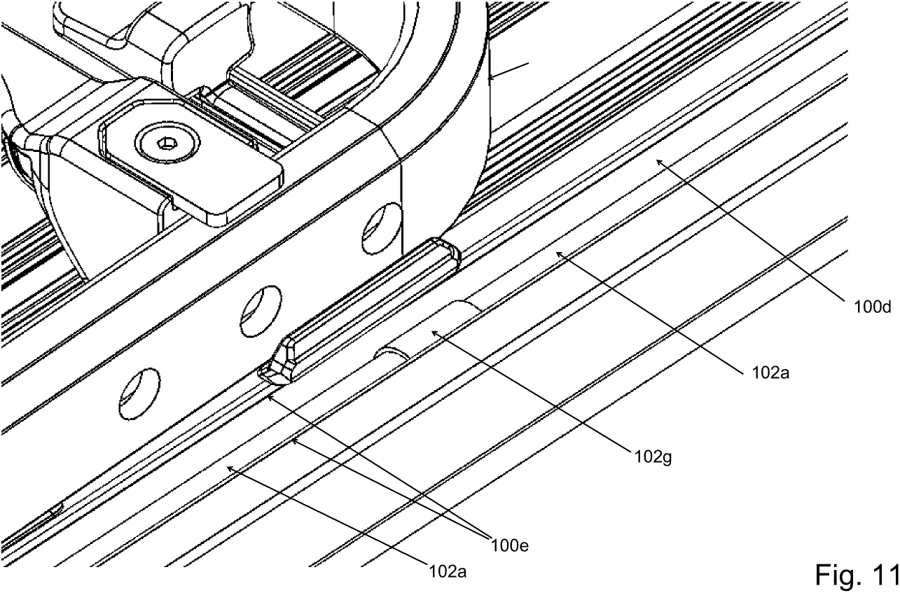

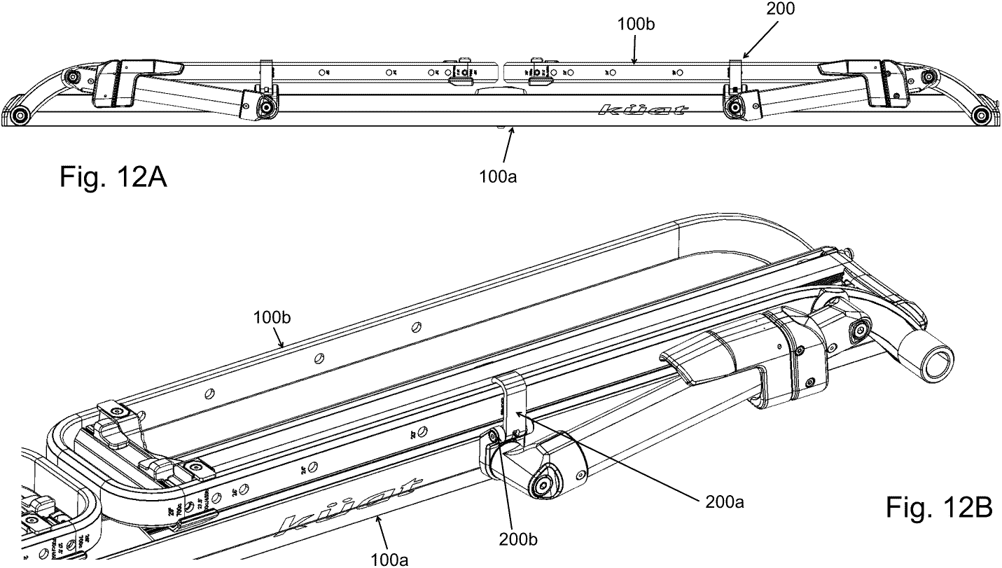

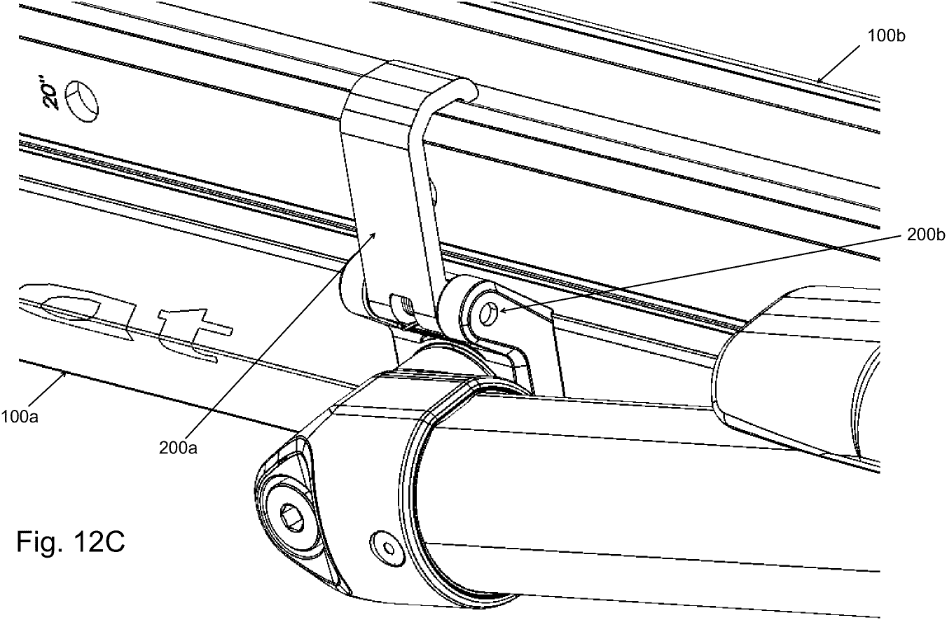

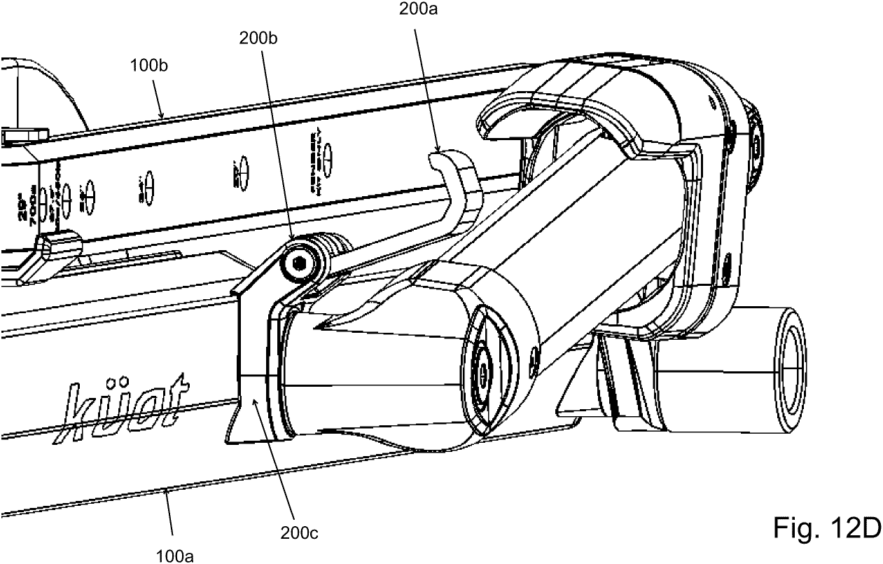

FIGS. 12A, 12B, 12C, and 12D depict a device for latching the wheel-securement arms of a bicycle rack. In bicycle racks that use two wheel-securement arms to hold the bicycle wheels, when not in use the arms typically rotate downwardly toward the platform on which the bicycle stands as shown in FIG. 12A. For aesthetic purposes it is desired that both wheel securement arms will align with one another or that they will both be disposed at the same angle to the platform portion of the rack. In some cases, the arms may not be held in an exactly symmetrical position with respect to the other arm due to variations in the mechanism by which they are held in place. In such cases it may be desired to provide a latch mechanism 200 to hold the arms in a desired position.

FIG. 12B depicts a bicycle rack with such a latch mechanism 200 attached to the platform and extending above the wheel securement arm to hold it in a desired attitude with respect to the platform and thus with respect to the other wheel securement arm. As can be seen in FIG. 12C when the depicted embodiment of the latch mechanism 200 is in a latched configuration it extends above the wheel securement arm to hold it down in the desired position. The latch component 200a is attached to the platform 100a by a bracket 200c with hinge 200b or similar mechanism. When a user desires to open the wheel securement arm to load a bicycle on the rack, the latch mechanism is disconnected from the wheel securement arm by disengaging them from one another, and then the latch mechanism is pivoted out of the way of the wheel securement arm as shown in FIG. 12D.

In some embodiments the latch component may be affixed to the wheel securement arm and disconnects from the platform instead of the vice versa arrangement shown in the figures. In some embodiments the latch mechanism may be made of a flexible material instead of being attached with a hinge. In some embodiments the latch mechanism may comprise a rack gear (similar to the insertion strap of a zip tie or a rack and pinion) that inserts into a ratchet tooth or pawl.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A bicycle rack with adjustable lock mechanism comprising:
a support member for supporting a bicycle;
a lengthwise cavity in the support member extending along at least a portion of the support member;
a slot extending along at least a portion of the lengthwise cavity;
a retention member slidably disposed in the lengthwise cavity;
a cable attached at a first end to the retention member and able to extend through and slide in the slot;
a lock configured to receive a second end of the cable to secure a bicycle on the rack;
wherein the retention member is not able to pass through the slot.

2. The bicycle rack with adjustable lock mechanism of claim 1 wherein the lengthwise cavity extends to an aperture in a first end of the support member.

3. The bicycle rack with adjustable lock mechanism of claim 1 wherein the retention member is spherical.

4. The bicycle rack with adjustable lock mechanism of claim 1 wherein at least a portion of the cavity has a circular cross-section.

5. The bicycle rack with adjustable lock mechanism of claim 2 further comprising a flange at the aperture having an opening that is wider than the slot but narrower than the cavity.

6. The bicycle rack with adjustable lock mechanism of claim 5 further comprising at least one collar attached to the cable, wherein the at least one collar is able to pass through the flange but is not able to pass through the slot.

7. The bicycle rack with adjustable lock mechanism of claim 1 wherein the lock is fixedly attached to the support member.

8. The bicycle rack with adjustable lock mechanism of claim 1 further comprising a magnet disposed an end of the cavity for urging the retention member to a retracted configuration.

9. A bicycle rack with adjustable lock mechanism comprising:
a support member for supporting a bicycle;
a retention member slidably captured in a longitudinal cavity in the support member;
a cable member attached at a first end thereof to the retention member;
a slot along at least a portion of the length of the longitudinal cavity;
a lock configured to receive a second end of the cable member;
wherein the cable or a portion of the retention member is configured to extend through the slot at a plurality of locations as the retention member slides in the longitudinal cavity.

10. The bicycle rack with adjustable lock mechanism of claim 9 wherein the retention member is spherical.

11. The bicycle rack with adjustable lock mechanism of claim 9 wherein the lock is attached to the support member.

12. The bicycle rack with adjustable lock mechanism of claim 9 wherein the longitudinal cavity extends to an aperture in a first end of the support member.

13. The bicycle rack with adjustable lock mechanism of claim 12 wherein the width of the aperture is less than the width of the longitudinal cavity.

14. The bicycle rack with adjustable lock mechanism of claim 13 wherein the width of the aperture is greater than the width of the slot.

15. The bicycle rack with adjustable lock mechanism of claim 14 further comprising at least one collar attached to the cable, wherein the width of the collar is greater than the width of the slot but less than the width of the aperture.

16. A bicycle rack with adjustable lock mechanism comprising:
a bicycle support member;
a retention member translatably secured to the bicycle support member;
a cable attached to the bicycle support member by the retention member at a cable attachment point; and
a lock for securing the cable to the bicycle support member;
wherein translation of the retention member translates the cable attachment point.

17. The bicycle rack with adjustable lock mechanism of claim 16 wherein the cable member is attached to the retention member by the lock.

18. The bicycle rack with adjustable lock mechanism of claim 16 wherein the retention member translates in a longitudinal cavity in the bicycle support member.

19. The bicycle rack with adjustable lock mechanism of claim 18 further comprising a slot extending along at least a portion of the longitudinal cavity.

20. The bicycle rack with adjustable lock mechanism of claim 19 wherein the cable is configured to extend through the slot at a plurality of positions along the length of the slot.
